(19) United States
(12) Patent Application Publication
(10) Pub. No.: US 2010/0082283 A1
(43) Pub. Date: Apr. 1, 2010

(54) TESTING DEVICE FOR PORTABLE ELECTRONIC DEVICES

(75) Inventors: YUNG-CHUNG LIN, Tu-Cheng (TW); JEN-HUNG LO, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: Chi Mei Communication Systems, Inc., Tu-Cheng City (TW)

(21) Appl. No.: 12/347,107

(22) Filed: Dec. 31, 2008

(30) Foreign Application Priority Data
Sep. 26, 2008 (CN) 200810304699.5

(51) Int. Cl. G06F 19/00

(52) U.S. Cl. 702/119

(57) ABSTRACT

A testing device for portable electronic devices includes a processor storing test programs corresponding to various portable electronic devices, a control module connected to the processor, and a testing apparatus connected to the control module and connecting to tested portable electronic devices. The processor directs the control module and the testing apparatus to test portable electronic devices according to predetermined test programs in a main control mode, and the control module cooperates with the testing apparatus to test portable electronic devices and directs the processor to select test programs according to the tested portable electronic device in a subsidiary control mode.

### BACKGROUND

1. Technical Field

The present disclosure relates to testing of portable electronic devices, and particularly to a testing device capable of detecting errors in portable electronic devices.

2. Description of Related Art

In manufacture of portable electronic devices such as mobile phones and personal digital assistants (PDAs), the assembled devices require quality testing. Generally, a typical testing device includes a testing apparatus and a processor. A test program and testing parameters are input to the processor, and the processor is connected to the testing apparatus. The portable electronic devices are connected to the testing apparatus, and the testing apparatus receives test data for each portable electronic device, for example, working electric potential, working current, resistance, stress and temperature thereof. The test data is then transferred to the processor, and the processor processes the test data and outputs test results.

In most typical testing devices, the processor can direct the testing apparatus to receive test data, but the testing apparatus cannot control the processor. When the testing device tests different kinds of portable electronic devices, the testing apparatus may receive different kinds of test data. However, the processor cannot automatically select different processing programs corresponding to the tested portable electronic devices, and its processing program needs to be manually changed. Further, it is difficult to detect errors of the processor during testing.

Therefore, there is room for improvement within the art, there being a need for a testing apparatus addressing the limitations described.

### BRIEF DESCRIPTION OF THE DRAWINGS

Many aspects of the present testing device can be better understood with references to the following drawings. The components in the various drawings are not necessarily drawn to scale, the emphasis instead being placed upon clearly illustrating the principles of the present testing device. Moreover, in the drawings, like reference numerals designate corresponding parts throughout the figures.

FIG. 1 is a diagram of a testing device, according to an exemplary embodiment.

FIG. 1 is a diagram of a control module of the testing device of FIG. 1

### DETAILED DESCRIPTION OF THE EXEMPLARY EMBODIMENTS

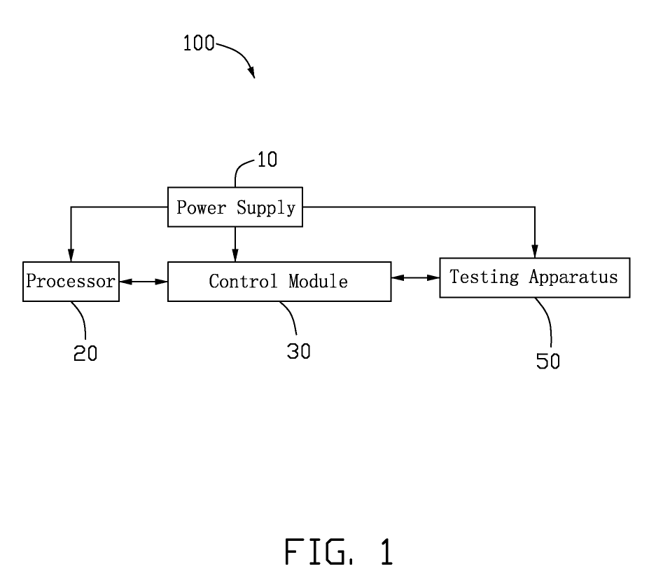

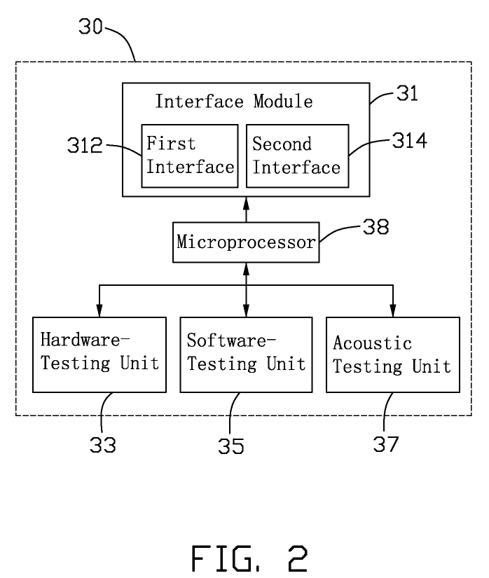

Referring to FIG. 1, a testing device 100 according to an exemplary embodiment of the present disclosure is provided. The testing device 100 can test many quality parameters, such as working electric potential, working current, resistance, allowable stress and temperature for portable electronic devices such as mobile phones and PDAs. The testing device 100 includes a power supply 10, a processor 20, a control module 30 and a testing apparatus 50. The processor 20, the control module 30, and the testing apparatus 50 are all connected to the power supply 10 to acquire a working electric potential. The processor 20 and the testing apparatus 50 are both connected to the control module 30.

The power supply 10 can be a typical direct current (DC) power supply. The testing apparatus 50 includes different measuring apparatuses, such as a multimeter, ergometer, thermometer, data flowmeter, acoustic simulator, soundproof chamber, and others. The testing apparatus 50 can receive test data of a portable electronic device being tested, such as, for example, working electric potential, working current, resistance, allowable stresses and temperature thereof and send the data to the control module 30. The processor 20 can be a computer or a single chip storing different kinds of test programs corresponding to different kinds of portable electronic devices. The processor 20 processes the test data sent from the control module 30 to obtain test results.

Also referring to FIG. 2, the control module 30 includes an interface unit 31, a hardware testing unit 33, a software testing unit 35, an acoustic testing unit 37, and a microprocessor 38. The interface unit 31 includes a first interface 312 connected to the processor 20 and a second interface 314 connected to the testing apparatus 50. The hardware testing unit 33, the software testing unit 35 and the acoustic testing unit 37 are all connected to the testing apparatus 50 via the second interface 314. The hardware testing unit 33 is connected to hardware measuring apparatuses of the testing apparatus 50, for example, the multimeter, the ergometer and the thermometer. The hardware testing unit 33 can test performance conditions such as resistance, working electric potential, working current, stresses, and temperature of a portable electronic device being tested. The software testing unit 35 is connected to software measuring apparatuses of the testing apparatus 50, for example, the data flowmeter. The software testing unit 34 can test hardware parameters such as download or upload speeds of the tested portable electronic devices. The acoustic testing unit 37 is connected to acoustic measuring apparatuses of the testing apparatus 50, for example, the acoustic simulator and the soundproof chamber. The acoustic testing unit can test acoustic parameters of the tested portable electronic devices.

The interface unit 31, the hardware testing unit 33, the software testing unit 35 and the acoustic testing unit 37 are all connected to the microprocessor 38. The microprocessor 38 stores a main control program and a subsidiary control program. When the microprocessor 38 executes the main control program, the control module 30 functions according to a main control mode. In the main control mode, the processor 20 sends control instructions to the control module 30 and the testing apparatus 50 to test portable electronic devices according to a predetermined test program stored in the processor 20, and receives parameters from the control module 30 fro processing. When the microprocessor 38 executes the subsidiary control program, the control module 30 works according to a subsidiary control mode. In the subsidiary control mode, the control module 30 and the testing apparatus 50 automatically identify the kind of the portable electronic device under test, and sends instructions to the processor 20 to select a corresponding test program. Thus, the control module 30 cooperates with the testing apparatus 50 to test parameters of the portable electronic device according to the selected test program, and then sends the received parameters to the processor 20 for processing.

In use, a portable electronic device is placed in the testing apparatus 50. The measuring apparatuses of the testing apparatus 50 are connected to the portable electronic device to receive parameters. The power supply 20 actuates the processor 20, the control module 30 and the testing apparatus 50.

The control modes can be selected by the microprocessor 38 of the control module 30. If a subsequent portable electronic device to be tested is the same as that previously tested, the main control mode can be selected. The microprocessor 38 executes the main control program and sends working instructions to the processor 20 via the interface module 31. Thus, the processor 20 receives the working instructions and executes the corresponding predetermined test program stored therein. The processor 20 sends control instructions to the testing units 33, 35, 37 and the testing apparatus 50 via the microprocessor 38 to test portable electronic devices, and then receives parameters from the control module 30 for processing. During testing, the control module 30 cooperates with the testing apparatus 50 to test different performance items of portable electronic devices. Particularly, the hardware testing unit 33 tests hardware performance such as resistance, working electric potential, working current, stress, and temperature of tested portable electronic devices. The software testing unit 35 is used to test performance items such as download or upload speeds of the portable electronic devices. The acoustic testing unit 37 tests acoustic performance items of the portable electronic devices.

If tested portable electronic devices to be tested are different, the subsidiary control mode can be selected. The microprocessor 38 executes the subsidiary control program and automatically identifies the portable electronic device to be tested via the testing units 33, 35, 37 and the testing apparatus 50. The microprocessor 38 sends instructions to the processor 20 to select a corresponding test program. Thus, the microprocessor 38 directs the testing units 33, 35, 37 and the testing apparatus 50 to test hardware, software and acoustic quality parameters of the portable electronic device according to the selected test program, and sends the received parameters to the processor 20 for processing.

Understandably, in the testing device 100, the processor 20 can direct the control module 30 to cooperate with the testing apparatus 50 to test portable electronic devices, while the control module 30 can also directs the processor to select test programs. When the testing device 100 tests different kinds of portable electronic devices, the microprocessor 38 executes the subsidiary control program, thus directing the processor 20 to select processing programs corresponding to various tested portable electronic devices, without manually directing the processor 20 to change the processing program. Further, this testing device 100 can also more easily detect errors in the processor in a test process.

It is to be further understood that even though numerous characteristics and advantages of the present embodiments have been set forth in the foregoing description, together with details of structures and functions of various embodiments, the disclosure is illustrative only, and changes may be made in detail, especially in matters of shape, size, and arrangement of parts within the principles of the present invention to the full extent indicated by the broad general meaning of the terms in which the appended claims are expressed.

What is claimed is:

1. A testing device for portable electronic devices, comprising:
a processor storing test programs corresponding to various portable electronic devices;
a control module connected to the processor; and
a testing apparatus connected to the control module and connecting with tested portable electronic devices; wherein the processor directs the control module and the testing apparatus to test portable electronic devices according to predetermined test programs in a main control mode, and the control module cooperates with the testing apparatus to test portable electronic devices and directs the processor to select test programs according to the tested portable electronic device in a subsidiary control mode.

2. The testing device as claimed in claim 1, wherein the control module includes a microprocessor connected to the processor to receive control instructions from the processor or control the processor.

3. The testing device as claimed in claim 2, wherein the microprocessor stores a main control program executed in the main control mode and a subsidiary control program executed in the subsidiary control mode.

4. The testing device as claimed in claim 1, wherein the control module includes a hardware testing unit connected to the testing apparatus to test hardware quality parameters of portable electronic devices.

5. The testing device as claimed in claim 1, wherein the control module includes a software testing unit connected to the testing apparatus to test software quality parameters of portable electronic devices.

6. The testing device as claimed in claim 1, wherein the control module includes an acoustic testing unit connected to the testing apparatus to test acoustic quality parameters of portable electronic devices.

7. The testing device as claimed in claim 1, further comprising a power supply connected to the processor, the control module and the testing apparatus to supply working electric potential.
